(19) United States
(12) Patent Application Publication
(10) Pub. No.: US 2010/0011904 A1
(43) Pub. Date: Jan. 21, 2010

(54) Motorcycle handlebar riser extensions

(76) Inventor: Richard C. Flanders, Clinton, TN (US)

Correspondence Address: Richard C. Flanders, 113 Iroquois Lane, Clinton, TN, 37716, US

(21) Appl. No.: 12/218,333

(22) Filed: Jul. 15, 2008

(51) Int. Cl. B62K 21/12

(52) U.S. Cl. 74/551.1

(57) ABSTRACT

Motorcycles are a one-size-fits-all device from the factory. Shorter people, people with shorter arms or operators who changes the grips from the longer factory grips to what is called ISO grips, which are shorter, find the length and position of the handlebars uncomfortable. The operator has to lean forward each time a turn is encountered, to turn the handlebars as far as required to maneuver the motorcycle. This invention, riser extensions, raises the handlebars up and repositions them rearward, allowing the operator more bend in the elbow and the ability to operate the motorcycle in a more upright position. The operator can safely turn the handlebars as far as required, comfortably making the operator safer. The riser extensions are fastened under the original factory risers and the original bolts and nuts are replaced with longer bolts and locknuts and are tightened to the original factory torque specifications of the originals.

### CROSS-REFERENCE TO RELATED APPLICATIONS

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

Motorcycles are a one-size-fits-all machine as they come from the factory. Shorter people, or people with shorter arms find the length and length and position of the handlebars uncomfortable. People that replace the factory handgrips with after market so called ISO Grips, which are shorter that the factory grips, are also affected. The operator has to lean forward, each time a slow speed turn is encountered, to turn the handlebars as far as required to maneuver the motorcycle in the desired direction. This invention, riser extensions, raises the handlebars up and repositions them rearward, allowing the operator more bend in the elbow and the ability to operate the motorcycle in a more upright position. This makes the operator safer.

### BRIEF SUMMARY OF THE INVENTION

These riser extensions, installed below the factory risers, raise the handlebars on a motorcycle up and rearward allowing more comfort and safer operation of a motorcycle for those that cannot operate a motorcycle in a comfortable upright position and maneuver the motorcycle in a safe manner due to the limited reach and uncomfortable seated position with the riser extensions installed. The riser extensions tend to decrease fatigue in the neck, back, and arms.

### BRIEF DESCRIPTION OF THE SEVERAL VIEWS OF THE DRAWING

FIG. 1/2 depicts the manufactured part of the invention as item 99. It shows a riser extension for particular make and models, but shows the general idea of the invention. The dimensions shown are for this particular application. The bill of materials are for this particular motorcycle models. In this model, the bolts that fastens the handlebars to the triple tree goes vertically downward through the original riser and triple tree to nuts provided. Other motorcycles are bolted from the bottom up, with threads in the riser instead of a bolt. Some risers are a different diameter than the one shown, others are other shapes instead of round. In this particular application, the original bolts and locknuts are “off the shelf” parts. FIG. 2/2 shows the adjacent parts with the manufactured part—the riser extension numbered 99. The riser extension fits between parts 19 and 20. Part 17, bolt, is provided and is of sufficient length to bolt the factory riser to the triple tree. The bolt, part 21, is replaced with a bolt provided and listed on the Bill of Materials listed on page 1/2. The characteristics of these bolts and nuts are provided in the bill of materials on page 1/2. Other applications of the riser extension would require bolts of sufficient length, head size, strength and thread pattern to accommodate the application. The nuts are tightened to the original factory torque specifications of the original riser bolts and nuts.

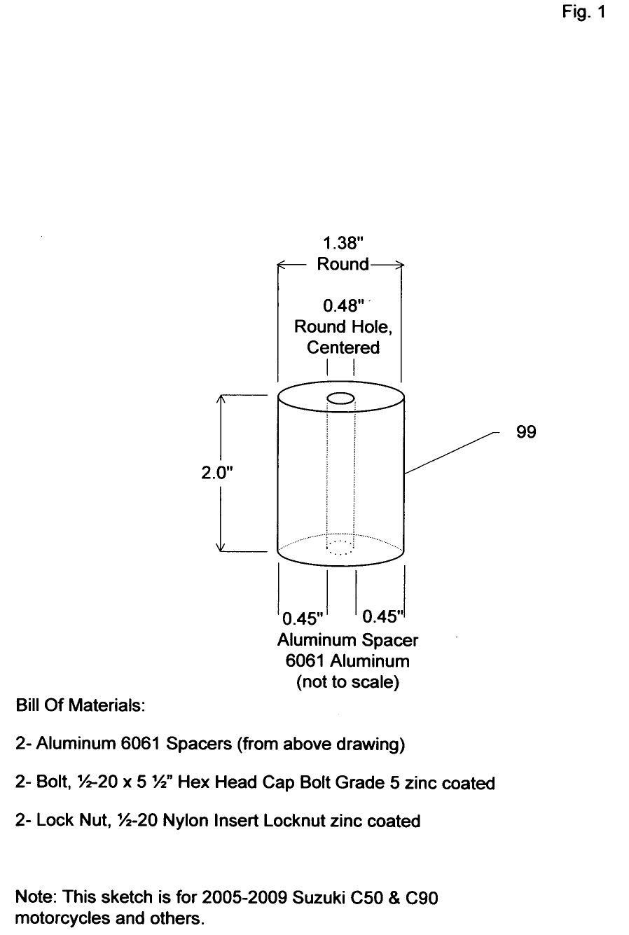

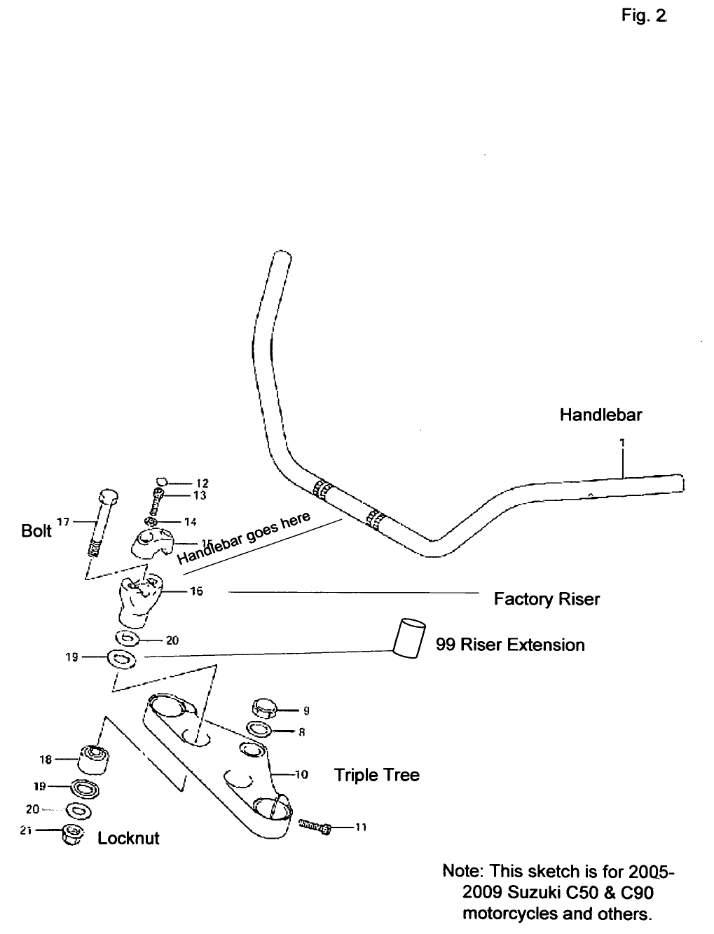

I claim:

1. On a motorcycle, where the handlebars are positioned incorrectly for comfort to the operator, riser extensions raise the handlebars up by an amount almost equal to the length of the riser extensions, and reposition the handlebars rearward to a smaller degree, both, causing the handlebar grips to be closer to the operators shoulders, allowing the operator to sit in a more straight up position, and allowing the operator some bend in the elbows, delivering more comfort all by inserting riser extensions (the invention) below the original factory extensions, whose dimensions are suitable for the make and model of motorcycle relative to the limits of the cables attached to the handlebars and a diameter and shape equal to the base of the factory risers and whose fastening method is similar to the method the factory risers are attached. The riser extensions fit between the factory risers and the triple tree. The triple tree provides a mounting place for the handlebar risers and the front forks and the body of the motorcycle.

2. A structural system adding additional safety to the operator, providing the ability to turn the handlebars to there extreme limits, in a safe and upright position, thus reducing stress to the back, arms, and neck, while allowing the operator to operate the motorcycle in the best posture for comfort and safety.

3. As to claim 1, operators often remove the longer factory handlebar grips in favor of more decorative, what are called ISO Grips, that are shorter than the factory grips, causing the issues described in claim 2. Riser extensions more than compensate for the shorter grips.
